(19) United States
(12) Patent Application Publication
(10) Pub. No.: US 2014/0315182 A1
(43) Pub. Date: Oct. 23, 2014

(54) MEDIA DISPLAY STAND DEVICE APPARATUS AND METHODS

(71) Applicant: Nashville Music Stand Company, LLC, Nashville, TN (US)

(72) Inventors: MICHAEL L. WILLIAMS, OLD HICKORY, TN (US); MARTIN J. STROBEL, JR., NASHVILLE, TN (US)

(73) Assignee: NASHVILLE MUSIC STAND COMPANY, LLC, Nashville, TN (US)

(21) Appl. No.: 13/865,034

(22) Filed: Apr. 17, 2013

(51) Int. Cl. G09B 19/00

(52) U.S. Cl. CPC G09B 19/00
USPC 434/365

(57) ABSTRACT

The present general inventive concept relates to the display of visual media by a media display stand apparatus and related methods. The apparatus accommodates and displays visual media, while simultaneously exposing the end-user participant to the presence of eye(s) or eye-like graphical representations. By including eye(s) or eye-like graphical representations, the end-user participant is motivated and encouraged to engage in desired behavior at higher frequency rates and longer durations than would otherwise occur in the absence of such eye(s) or eye-like graphical representations.

### FIELD

The present inventive concept relates generally to the display of various media in the context of education, training, coaching, and other endeavors that can be enhanced by motivational techniques and modalities. In particular, the general inventive concept relates to the inclusion of eye(s) or eye-like graphical representations as a component of performing a given task or activity that requires the viewing of visual media; the presence of the eye(s) or eye-like graphical representations act as encouragement and motivation to practice or engage in a given task. Specifically, the inventive concept relates to an apparatus and related methods for displaying media, wherein the apparatus or method incorporates eye(s) or eye-like graphical representations. A user who is consciously or subconsciously aware of the eye(s) or eye-like graphical representations tends to feel like he or she is being observed, which serves a number of purposes, including but not limited to motivating the user to increase the frequency of engaging in a given task and encouraging the user to engage in a given task for a longer duration, with greater focus, or with increased dedication.

### BACKGROUND

Various devices and methods are available to assist with learning, education, and training activities. Some examples include: U.S. Pat. Nos. 6,699,043; 6,419,495; 2,220,719; 6,882,824; and 7,507,091; U.S. Published Patent Application No. 2002/0140688; and International Patent Application Publication No. WO 2009/071297.

Many activities related to education, learning, training, coaching, and similar endeavors require repetition, perseverance, and tenacity. Known methods and devices used to track a user's activity, progress and/or status fall short due to complexity and/or expense. What is needed is an apparatus and method that is relatively simple and inexpensive that encourages he increase in frequency, duration, and/or effectiveness of a repetitious activity.

### SUMMARY

Although tenacity, on occasion, can be achieved via independent motivation, in the vast majority of instances, some sort of monitoring (i.e., the feeling of being watched) serves as a strong motivator to engage in cooperative behavior in the completion/mastery of a given task. The general inventive concept relates to various endeavors, including but not limited to, the playing and performance of music; the creation of art; academic learning and study; gaming; or any other endeavors where a user benefits from practice, diligence, and tenacity.

When individuals feel as though they are being watched by eye images (i.e., painted eyes, printed eyes, etc.), those individuals are more likely to act in a cooperative manner. Eye(s) and eye-like graphical representations encourage individuals to engage in cooperative behavior, in greater frequency, duration, and intensity. Relevant scholarly research has shown that individuals behave differently when being watched. That feeling of being watched causes most individuals to follow expected social norms. In fact, experimental research has shown that even the images of eye(s) or eye-like graphical representations can significantly impact human behavior. (See Ernest-Jones, et al., “Effects of eye images on everyday cooperative behavior: a field experiment”; Evolution and Human Behavior 32 (2011) 172-178.)

Those and related studies further corroborate the finding that the presence of eye(s) or eye-like graphical representations can increase cooperative behavior in individuals exposed to such images. The presence of those eye(s) or eye-like graphical representations has been shown to subtly, but noticeably, increase cooperative behavior (i.e., what an individual believes he/she should do as opposed to what he/she desires to do). (Id.) Moreover, the effect of the feeling of being watched is enhanced in circumstances where an individual is alone or in a sparsely populated area. Engaging in endeavors such as studying, practicing, or other similar tasks often occur in isolation or in sparsely populated areas. (Id.)

The inventive concept relates to the theory of ‘nudge psychology,’ which suggests that people may behave better if the best option in a given situation is highlighted for them, but all other options are still left open, so the person isn't forced into one particular action. The inventive concept has the effect of ‘nudging’ people into engaging in a desired behavior or activity. Because the feeling of being watched has been connected to cooperative behavior; the inventors discovered that providing the appropriate environment, using the appropriate device and/or methods, leads to the larger motivational/encouragement goals of enhanced education, training, practice, coaching, and other related endeavors.

For example, at times an individual may not desire to engage in a given activity, such as studying, practicing, or other activities required to complete and/or master a given endeavor. The inventive concept capitalizes upon the aforementioned behavioral studies by including eye(s) or eye-like graphical representations on media display stands, which recreate the feeling of being watched in an end-user participant.

The inventors have developed new devices and related methods aimed at achieving high levels of motivation by incorporating eye(s) and/or eye-like graphical representations into display media intended to be used by various individuals in various situations. These new devices and related methods overcome shortcomings in the prior art. The inventors have discovered that by incorporating eye(s) and/or eye-like graphical representations into display media, heightened motivation and cooperative behavior is readily achieved at the same or greater effectiveness at the same or lower costs than the prior art.

One object of the present inventive concept is to provide a media display stand with eyes or eye-like graphical representations, the presence of which influences an end-user participant to engage in a given task for longer durations and with higher frequency than would otherwise occur in the absence the eye(s) or eye-like graphical representations. The device includes a generally upright planar component shaped and angled to display one or more visual media; a shelf component extending tangentially from the generally upright planar component sized and shaped to retain the visual media in place resting against the upright planar component and the shelf component; a set of eye(s) or eye-like graphical representations on said generally upright planar component; and a base component connected to the upright planar component sized and shaped to maintain the planar component in an upright position on a variety of different surfaces.

The device includes eye(s) or eye-like graphical representations. Those eye(s) or eye-like graphical representations serve the purpose of promoting cooperative behavior, providing motivation and encouragement, and subtly nudging the end-user participant to engage in certain desired activities/tasks/behaviors. While many other devices attempt to promote desired activities/tasks/behaviors, such as learning, training, or practice, such devices lack the eye(s) or eye-like graphical representations shown in relevant research to promote such cooperative behavior. In some exemplary embodiments discussed in further detail below, the eye(s) or eye-like graphical representations may be incorporated in multiple configurations on the generally upright planar component. By incorporating this feature into the device, the end-user participant gains the flexibility to display a vast array of visual media on the media display stand, while maintaining the motivational benefit the eye(s) or eye-like graphical representations impart on the end-user participant. Accordingly, media of differing dimensions or materials can easily be accommodated for visual display to the end-user participant. Other exemplary embodiments may be configured wherein the eye(s) or eye-like graphical representations protrude from the generally upright planar component, such that the eye(s) or eye-like graphical representations serve the dual purpose of promoting cooperative behavior and also detachably affixing the visual display media in a desired position/configuration for end-user participant observation. In such embodiments, the end-user participant gains the added advantage of using the media display stand on uneven surfaces or in windy environments without the concern of the displayed visual media moving out of view of the end-user participant.

Other exemplary embodiments may include an additional elongated shaft component affixed to the generally upright planar component and connecting the planar component to the base. In some embodiments, the shaft component is extendible to multiple height configurations, which accommodates end-user participants of various heights and positioning. The variable configurations also accommodate end-user participant usage in standing, seated, kneeling, and other positions while viewing the visual media. Such features are beneficial when the media display stand is used in an environment with a high likelihood of incidental/unintentional contact with the device.

Another object of the present inventive concept is to provide a method of displaying visual media. The method includes placing one or more visual media on the apparatus described above such that the eye(s) or eye-like graphical representations are visible to a user. In some embodiments, the method includes rearranging the eye-like graphical representations such that the eye-like graphical representations are visible to the user. In some embodiments, the method includes temporarily securing the visual media to the generally upright planar component with the eye-like graphical representations such that the eye-like graphical representations are visible to a user. In some embodiments, the method includes extending the shaft component to a preferred height configuration such that the eye-like graphical representations are visible to a user.

The foregoing and other objects are intended to be illustrative of the general inventive concept and are not meant in a limiting sense. Many possible embodiments of the invention may be made and will be readily evident upon a study of the entire specification and accompanying drawings comprising a part thereof. Various features and subcombinations of the general inventive concept may be employed without reference to other features and subcombinations. Other objects and advantages of the general inventive concept will become apparent from the following description taken in connection with the accompanying drawings, wherein is set forth by way of illustration and example, an embodiment of this invention and various features thereof.

### BRIEF DESCRIPTION OF THE DRAWINGS

These and/or other aspects and utilities of the present general inventive concept will become apparent and more readily appreciated from the following description of the embodiments, taken in conjunction with the accompanying drawings. For the purpose of illustration, forms of the present general inventive concept which are presently preferred are shown in the drawings; it being understood, however, that the general inventive concept is not limited to the precise arrangements and instrumentalities shown. In the drawings:

FIG. 1 is a front view of an exemplary embodiment of the present general inventive concept.

FIG. 2 is a perspective view of a second exemplary embodiment of the present general inventive concept.

FIG. 3 is a perspective rear view of FIG. 2.

FIG. 4 is a perspective view of a third exemplary embodiment of the present general inventive concept.

FIG. 5 is a perspective rear view of FIG. 4.

### DETAILED DESCRIPTION

The present general inventive concept provides a media display stand device apparatus.

The device includes a generally upright planar component. This generally upright planar component acts as a primary support for visual media to be displayed by an end-user participant. The visual media may include, but is not limited to, sheet music, magazines, loose papers, books, pamphlets, electronic display media, and other types of visual media. The visual media is placed upon the generally upright planar component, which supports the visual media at an angle and position easily viewable by the end-user participant. In the present general inventive concept, a shelf component extends tangentially, outward away from the generally upright planar component. The shelf component acts to prevent the visual media from moving or sliding off of the generally upright planar component; in this way, the shelf component maintains the position of the visual media for observation by the end-user participant. A single eye, or in preferred embodiments, a set (pair) of eyes or eye-like graphical representations are integrally incorporated into the present general inventive concept. Solving the shortcomings of the prior art, the eye(s) or eye-like graphical representations promote cooperative behavior and participation by the end-user participant. The ‘nudge’ psychology and instinct motivates and encourages end-user participants to engage in the desired task/activity/endeavor to completion/mastery. The eye(s) or eye-like graphical representations are sized, shaped and located such that they are visible to the user when viewing the visual media on the media display stand. The device also includes a base component. The base component is connected to the generally upright planar component. The base component is sized and shaped to maintain the planar component in a generally upright position on a variety of different surfaces.

In some embodiments, an elongated shaft component is affixed to the generally upright planar component. The shaft connects the planar component to the base. The integration of the shaft component enables end-user participants to utilize the media display stand in situations where a flat surface is either unavailable or undesirable for a given endeavor. In some embodiments, that shaft component is extendible to multiple different height configurations. Such capability enables the media display stand to accommodate end-users of differing dimensions (i.e., height, weight, etc.).

The eye(s) or eye-like graphical representations are essential to the overall function of the apparatus and methods relating to the media display stand. In some embodiments, the eye(s) or eye-like graphical representations can be arranged in multiple different configurations. This capability enables the end-user to keep the eye(s) or eye-like graphical representations within line-of-sight while viewing visual media of differing sizes, shapes, or dimensions. In some embodiments, the eye(s) or eye-like graphical representations protrude from the generally upright planar component. In some embodiments the eye(s) or eye-like graphical representations detachably affix the visual media to the generally upright planar component, thereby working in conjunction with the shelf component to achieve further stability of the visual media. Such stability may be desirable when utilizing the present general inventive concept in environmental conditions that would cause the visual media to become dislodged in the absence of such a feature.

The base component acts as a stabilizing element in the present general inventive concept. Such stabilization may be desirable or necessary in instances involving uneven surfaces or environments with a high probability of accidental contact with the media display stand.

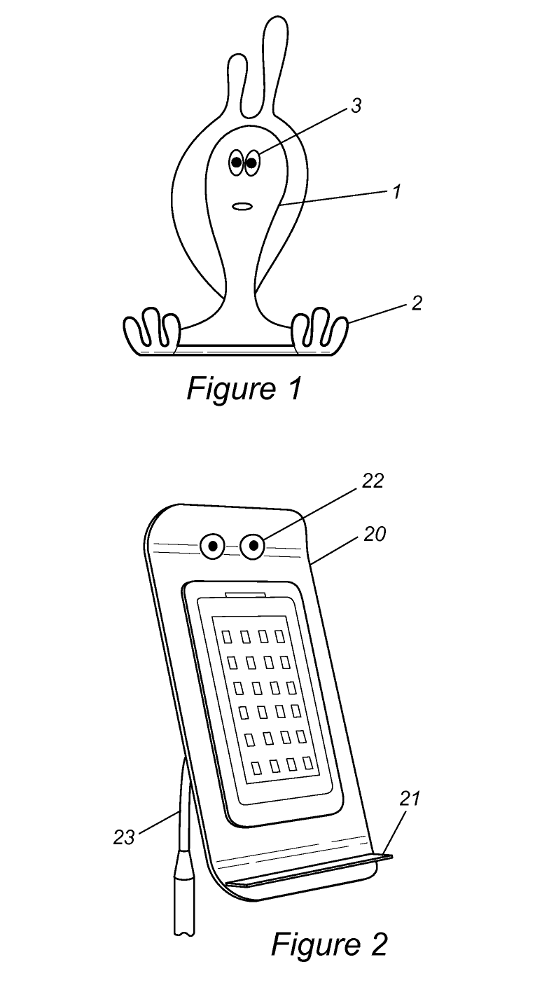

Referring to the Figures, FIG. 1 depicts a front view of an exemplary embodiment of the present general inventive concept. A generally upright planar component 1 includes a shelf component 2 extending tangentially outwardly away from the generally upright planar component 1. A single eye, pair of eyes or eye-like graphical representations 3 are present on the surface of the generally upright planar component 1. End-user participants place visual media upon the generally upright planar component 1, which displays the visual media in a manner observable to the end-user participant. The bottom edge of the visual media rests on the shelf component 2, and the back side of the visual media rests against the generally upright planar component 1 to hold the visual media in place for the duration of a given activity/task/endeavor. The eye(s) or eye-like graphical representations 3 remain within line-of-sight of the end-user participant while the visual media is being displayed by the media display stand. Keeping the eye(s) or eye-like graphical representations 3 within in line-of-sight of the end-user participant achieves enhanced motivations and encouragement to engage in the desired activity/task/endeavor.

FIG. 2 shows a perspective view of a second exemplary embodiment of the present general inventive concept. The generally upright planar component 20 acts to display various types of visual media. The shelf component 21 acts in conjunction with the generally upright planar component 20 to hold the visual media in place during a given activity/task/endeavor. The eye(s) or eye-like graphical representations 22 remain within line-of-sight of the end-user participant while the visual media is being displayed by the media display stand. A shaft component 23 is affixed to the generally upright planar component 20, such that the visual media can be displayed by the media display stand without the need for another surface upon which to rest the apparatus.

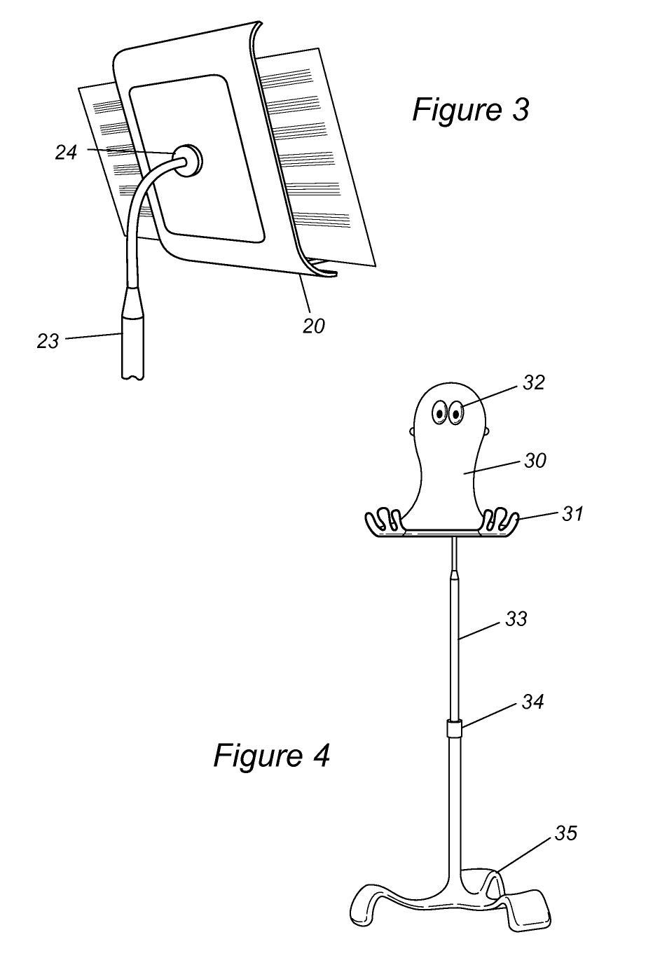

FIG. 3 shows a perspective rear view of the exemplary embodiment shown in FIG. 2.

In FIG. 3, the point of affixation 24 between the generally upright planar component 20 and the shaft component 23 is shown in greater detail.

FIG. 4 depicts a perspective view of a third exemplary embodiment of the present general inventive concept. In this embodiment, the generally upright planar component 30 acts to display various types of visual media. The shelf component 31 acts in conjunction with the generally upright planar component 30 to hold the visual media in place during a given activity/task/endeavor. The eye(s) or eye-like graphical representations 32 remain within line-of-sight of the end-user participant while the visual media is being displayed by the media display stand. In this embodiment, the eye(s) or eye-like graphical representations 32 protrude and detachably affix visual media to the generally upright planar component 30. Incorporating this feature enables the end-user to further secure visual media in a desired position for observation. Moreover, the eye(s) or eye-like graphical representations 32 show the capability of multiple position configurations, such that visual media of varying sizes, shapes, or dimensions can be accommodated by the device. A shaft component 33 is affixed to the generally upright planar component 30, such that the visual media can be displayed by the media display stand without the need for another surface upon which to rest the apparatus. The shaft component 33 is also shown to be capable of multiple height configurations due to the presence of an adjustment knob 34. The end-user participant can vary the height of the present general inventive concept by engaging the adjustment knob 34, shortening or lengthening the shaft component 33, and reengaging the adjustment knob 34 to ensure proper height. A base component 35 is affixed to the shaft component 33 at a distal end with respect to the generally upright planar component 30. The base component 35 stabilizes the media display stand on multiple different surfaces.

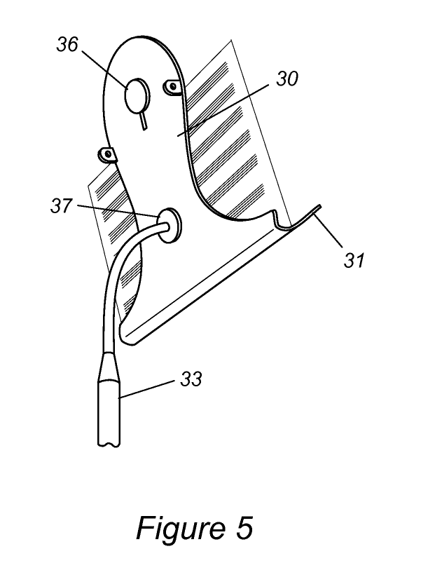

FIG. 5 is a perspective exterior rear view of FIG. 4. In this view, the point of affixation 37 between the shaft component 33 and the generally upright planar component is shown in greater detail. This view also depicts an attachment 36 of the eye(s) or eye-like graphical representations (shown as 32 in FIG. 4). This point of attachment 36 also demonstrates the multiple position configurations the protruding eye(s) or eye-like graphical representations. FIG. 5 also shows another perspective of the shelf component 31 and the generally upright planar component 30 used to hold the visual media in place.

The exemplary embodiments of the present general inventive concept are implemented as a media display device. Thus, while the present general inventive concept has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use; and applications in contexts outside of education, training, practice, and similar endeavors.

It is also to be understood that the claims to follow are or will be intended to cover all of the generic and specific features of the invention herein described, and all statements of the scope of the invention which, as a matter of language, might be said to fall therebetween. Hence, the proper scope of the present general inventive concept should be determined only by the broadest interpretation of such claims so as to encompass all such modifications as well as all relationships equivalent to those illustrated in the drawings and described in the specification.

Finally, it will be appreciated that the purpose of the annexed Abstract is to enable the

U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed is:

1. An media display stand apparatus comprising:
a generally upright planar component shaped and angled to display one or more visual media;
a shelf component extending tangentially from the generally upright planar component sized and shaped to retain the visual media in place resting against the generally upright planar component and the shelf component;
at least one eye-like graphical representation on said generally upright planar component; and
a base component connected to said generally upright planar component sized and shaped to maintain the planar component in a generally upright position on a variety of different surfaces.

2. The apparatus of claim 1, further comprising an elongated shaft component affixed to said generally upright planar component and connecting said generally upright planar component to said base component.

3. The apparatus of claim 1, wherein said at least one eye-like graphical representation is capable of being rearranged in multiple different configurations on said generally upright planar component.

4. The apparatus of claim 1, wherein said at least one eye-like graphical representation protrudes from said generally upright planar component.

5. The apparatus of claim 1, wherein said at least one eye-like graphical representation is sized, shaped and configured to temporarily secure said visual media to said generally upright planar component.

6. The apparatus of claim 1, wherein said shaft component is extendible to multiple different height configurations.

7. The apparatus of claim 1, wherein said at least one eye-like graphical representation comprises a pair of eyes.

8. A method of displaying visual media, said method comprising:
placing one or more visual media on the apparatus of claim 1 such that said at least one eye-like graphical representation is visible to a user.

9. A method of displaying visual media, said method comprising:
placing one or more visual media on the apparatus of claim 3; and
rearranging one or more of said at least one eye-like graphical representation to a configuration such that said eye-like graphical representation is visible to a user.

10. A method of displaying visual media, said method comprising:
placing one or more visual media on the apparatus of claim 5; and
temporarily securing said visual media to said generally upright planar component with said eye-like graphical representation such that said eye-like graphical representation is visible to a user.

11. A method of displaying visual media, said method comprising:
placing one or more visual media on the apparatus of claim 6; and
extending said shaft component to a preferred height configuration such that said eye-like graphical representation is visible to a user.
